(19) United States
(12) Patent Application Publication
(10) Pub. No.: US 2011/0127967 A1
(43) Pub. Date: Jun. 2, 2011

(54) ELECTROLYTE AND ENERGY STORAGE DEVICE

(76) Inventors: Grigorii Lev Soloveichik, Latham, NY (US); Oleg Ivanovich Boyko, Kyiv (UA); Oleksandr Myhailovych Gudymenko, Kyiv (UA)

(21) Appl. No.: 12/892,473

(22) Filed: Sep. 28, 2010

(30) Foreign Application Priority Data
Sep. 29, 2009 (UA) 200909961

(51) Int. Cl. H02J 7/00; H01M 10/02; H01M 10/0562

(52) U.S. Cl. 320/135; 429/199; 429/319

(57) ABSTRACT

In one aspect, an energy storage device component comprising a transition metal cathode comprising a transition metal selected from the group consisting of nickel, iron, cobalt, chromium, manganese, molybdenum, antimony and combinations thereof; a solid sodium halide phase; and an electrolyte phase is provided. The electrolyte phase comprises an electrolyte composition prepared from sodium chloride, lithium chloride and aluminum trichloride. The electrolyte composition is in contact with the cathode. The electrolyte composition comprises the reaction products obtained from an initial mixture of sodium chloride (NaCl), lithium chloride (LiCl) and aluminum trichloride (AlCl₃). The initial mixture being characterized by an initial molar ratio of (NaCl+LiCl):AlCl₃ in a range of from about 0.45:0.55 to about 0.55:0.45 and an initial molar ratio of NaCl:LiCl in a range of from about 0.1:1 to about 4:1. Also provided is an energy storage device and a method of operating the energy storage device.

The invention relates generally to an energy storage device, more particularly to an energy storage device component and a method of operating an energy storage device.

### BACKGROUND

Metal chloride batteries comprising a molten sodium anode and a beta-alumina solid electrolyte are widely employed for energy storage applications. The energy storage applications may include mobile applications due to their high energy density and long cycle life. To be applicable for mobile applications like hybrid locomotives or plug-in hybrid electric vehicles (PHEV), sodium-metal chloride batteries must tolerate power surges (high currents) during both battery charging and discharging without loss in the working capacity and the cycle lifetime. For example, sodium nickel chloride batteries possess both high theoretical energy density (790 Wh/kg) and operability over a wide temperature range. The cathode of such batteries typically comprises a transition metal, (for example nickel, and/or iron) sodium chloride NaCl and a molten secondary electrolyte, NaAlCl₄. The cathode is typically isolated from the anode by a separator, typically a cation permeable inorganic structure such as a beta-alumina sheet, tube or sheath.

The molten electrolyte transports ions to and from the separator on the cathode side. The melting point of the molten electrolyte has to be below the minimum operating temperature of the battery, which is defined by the ionic conductivity of the solid Na⁺ conducting electrolyte. The molten electrolyte is usually sodium tetrachloroaluminate NaAlCl₄ having a melting point in a range from about 152° C. to about 156° C. During the battery charging process, sodium chloride is consumed and is converted into sodium metal at the anode and nickel chloride at the cathode. During this process sodium cations are transferred selectively through the separator to the anode. The direction of sodium ion transport through the separator, the deposition of sodium metal at the anode, and the formation of nickel chloride at the cathode are reversed during the discharging process. A serious limitation to battery performance is ascribed to the limited solubility of sodium chloride in molten NaAlCl₄ (about 0.8 mol. % or 0.5 wt. % at 300° C.). Thus, the rates of processes associated with the formation of elemental sodium at the anode during the charging process are limited by the poor solubility of sodium chloride in the molten electrolyte. Low solubility of sodium chloride effectively limits the rate of dissolution of sodium chloride into the molten electrolyte which tends to limit the transport of sodium in the cell which in-turn affects the battery power. In addition, formation of sodium chloride during discharging results in crystallization of at least a portion of the sodium chloride formed. Such crystallization may result in the formation of large lumps of sodium chloride with yet a lower rate of dissolution and loss of battery capacity.

Different cell designs have been suggested, for example, a cloverleaf-like shape of a beta-alumina separator, as a means to alleviate the effects of low solubility of sodium chloride in the molten electrolyte and to improve sodium ion transport in the battery. However, cell design alone cannot solve the problem of limited charge rate resulting from low solubility of sodium chloride in the molten electrolyte.

Therefore, there exists a need for an improved solution to the long-standing problem of the low rate at which batteries may be charged and discharged. In addition further improvements of the battery power are needed. These and other limitations of current energy storages devices are addressed by the present invention.

### BRIEF DESCRIPTION

In one aspect, the present invention provides enhancement to energy storage devices incorporating a molten electrolyte through a novel electrolyte phase that significantly improves the cell working capacity and decreases capacity degradation rate and cost.

In one aspect, the present invention provides an energy storage device component comprising a transition metal cathode comprising a transition metal selected from the group consisting of nickel, iron, cobalt, chromium, manganese, molybdenum, antimony and combinations thereof; a solid sodium halide phase; and an electrolyte phase. The electrolyte phase comprises an electrolyte composition prepared from sodium chloride, lithium chloride and aluminum trichloride. The electrolyte composition is in contact with the cathode. The electrolyte composition comprises the reaction products obtained from an initial mixture of sodium chloride (NaCl), lithium chloride (LiCl) and aluminum trichloride (AlCl₃). The initial mixture being characterized by an initial molar ratio of (NaCl+LiCl):AlCl₃ in a range of from about 0.45:0.55 to about 0.55:0.45 (or expressed another way 0.82:1 to about 1.22:1) and an initial molar ratio of NaCl:LiCl in a range of from about 0.1:1 to about 4:1.

In another aspect, the present invention provides an energy storage device comprising a first compartment comprising an anode; a second compartment and a sodium cation conducting barrier layer disposed between the first compartment and the second compartment. The second compartment comprises a transition metal cathode comprising a transition metal selected from the group consisting of nickel, iron, cobalt, chromium, manganese, molybdenum, antimony and combinations thereof; a solid sodium halide phase; and an electrolyte phase in contact with the cathode. The electrolyte phase comprises an electrolyte composition prepared from sodium chloride, lithium chloride and aluminum trichloride. The electrolyte composition comprises the reaction products obtained from an initial mixture of sodium chloride (NaCl), lithium chloride (LiCl) and aluminum trichloride (AlCl₃). The initial mixture being characterized by an initial molar ratio of (NaCl+LiCl):AlCl₃ in a range of from about 0.45:0.55 to about 0.55:0.45 and an initial molar ratio of NaCl:LiCl in a range of from about 0.1:1 to about 4:1.

In yet another aspect, the present invention provides a method of operating an energy storage device comprising the steps of (a) applying a effective voltage differential to the cathode and anode of an energy storage device to provide a energy storage device comprising stored energy; and (b) discharging the stored energy through a “resistive load”, wherein the energy storage device is operated at a temperature in a range from about 250° C. and about 350° C. during the discharging step. The energy storage device comprises a first compartment comprising an anode; a second compartment comprising a transition metal cathode, a solid sodium halide phase, and a molten electrolyte phase; and a sodium cation conducting barrier layer disposed between the first compartment and the second compartment. The transition metal cathode comprises a transition metal selected from the group consisting of nickel, iron, cobalt, chromium, manganese, molybdenum, antimony and combinations thereof. The molten electrolyte phase comprises an electrolyte composition prepared from sodium chloride, lithium chloride and aluminum trichloride. The electrolyte composition is in contact with the cathode, and the electrolyte composition comprises the reaction products obtained from an initial mixture of sodium chloride (NaCl), lithium chloride (LiCl) and aluminum trichloride (AlCl₃). The initial mixture being characterized by an initial molar ratio of (NaCl+LiCl):AlCl₃ in a range of from about 0.45:0.55 to about 0.55:0.45 and an initial molar ratio of NaCl:LiCl in a range of from about 0.1:1 to about 4:1.

In another aspect, the present invention provides an energy storage device comprising a first compartment comprising a sodium anode; a second compartment comprising a transition metal cathode, a solid sodium halide phase, an electrolyte phase in contact with the cathode, and a sodium cation conducting barrier layer comprising beta alumina disposed between the first compartment and the second compartment. The electrolyte phase comprises an electrolyte composition prepared from sodium chloride, lithium chloride and aluminum trichloride. The electrolyte composition is in contact with the cathode, the electrolyte composition comprises the reaction products obtained from an initial mixture of sodium chloride (NaCl), lithium chloride (LiCl) and aluminum trichloride (AlCl₃), the initial mixture being characterized by an initial molar ratio of (NaCl+LiCl):AlCl₃ in a range of from about 0.45:0.55 to about 0.55:0.45 and an initial molar ratio of NaCl:LiCl in a range of from about 0.1:1 to about 4:1.

These and other features, aspects, and advantages of the present invention may be understood more readily by reference to the following detailed description.

### BRIEF DESCRIPTION OF THE DRAWING FIGURES

These and other features, aspects, and advantages of the present invention will become better understood when the following detailed description is read with reference to the accompanying drawings in which like characters represent like parts throughout the drawings, wherein:

FIG. 1 is a liquidus curve of the pseudo-binary LiAlCl₄—NaAlCl₄ system containing additional 5 mol. % NaCl.

FIG. 2 illustrates electrical conductance behavior of the electrolyte in the energy storage device component, in accordance with one aspect of the invention.

### DETAILED DESCRIPTION

In the following specification and the claims, which follow, reference will be made to a number of terms, which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

It is also understood that terms such as “top.” “bottom,” “outward,” “inward,” and the like are words of convenience and are not to be construed as limiting terms. Furthermore, whenever a particular feature of the invention is said to comprise or consist of at least one of a number of elements of a group and combinations thereof, it is understood that the feature may comprise or consist of any of the elements of the group, either individually or in combination with any of the other elements of that group.

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As noted, in one embodiment the present invention provides an energy storage device component comprising a transition metal cathode, a solid sodium halide phase and an electrolyte phase.

In various embodiments of the present invention, the cathode comprises a cathodic material is the material that supplies, electrons during charging as part of a redox reaction. An anode, accepts electrons during charging as part of the redox reaction. The cathode may include cathodic materials having differing functions: an electrode material, a support structure, and a current collector. The electrode material is present in the cathode as a participating electrochemical reactant in which it is alternately in an oxidized state, and a reduced state. Those of ordinary skill in the art will understand that during charging and discharging the electrode material may comprises chemical species in an oxidized state and chemical species in a reduced state, for example nickel chloride, a chemical species in an oxidized state, and zero-valent nickel metal, a chemical species in a reduced state. The support structure does not undergo much if any chemical reaction during the charge/discharge steps, but does provide a medium for electron transport, and support for the electrode material as the electrode material undergoes chemical reaction in the oxidation-reduction reaction characterizing the energy storage device. In addition, the support structure may provide a surface upon which solids may precipitate. The electrolyte is the medium that provides for ion transport mechanism between the positive and negative electrodes of an electrochemical cell, and in various embodiments, may act as a solvent for the oxidized form of the electrode material. Additives that facilitate ion transport may in certain embodiments be distinguished from the electrolyte.

In various embodiments, the present invention provides energy storage device components and energy storage devices comprising a transition metal cathode. The transition metal cathode comprises a zero-valent transition metal. In one embodiment, the zero-valent transition metal is selected from the group consisting of nickel, iron, cobalt, chromium, manganese, molybdenum, antimony and combinations thereof. In another embodiment, the transition metal is at least one metal selected from titanium, vanadium, niobium, molybdenum, chromium, manganese, iron, antimony, nickel, cobalt, silver, cadmium, tin, lead, or zinc. In yet another embodiment, the zero-valent transition metal is nickel. In another embodiment, the transition metal cathode may further comprise aluminum metal.

The energy storage device components and devices provided by the present invention include an electrolyte phase. The electrolyte phase includes an electrolyte composition in contact with the cathode. The electrolyte composition is prepared from sodium chloride (NaCl), lithium chloride (LiCl) and aluminum trichloride (AlCl₃). The electrolyte composition includes reaction products obtained from an initial mixture of sodium chloride (NaCl), lithium chloride (LiCl) and aluminum trichloride (AlCl₃). In one embodiment, the initial mixture is characterized by an initial molar ratio of (NaCl+LiCl):AlCl₃ in a range from about 0.45:0.55 to about 0.55:0.45 and an initial molar ratio of NaCl:LiCl in a range from about 0.1:1 to about 4:1.

In another embodiment, the initial molar ratio of NaCl:LiCl is in a range of from about 0.1:1 to about 0.65:1. In yet another embodiment, the initial molar ratio of (NaCl+LiCl):AlCl₃ is in a range of from about 0.47:0.53 to about 0.55:0.45 and the initial molar ratio of NaCl:LiCl is in a range of from about from 0.1:1 to about 0.25:1. The initial molar ratios of the sodium chloride (NaCl), lithium chloride (LiCl) and aluminum trichloride (AlCl₃) are independent of the presence of any other component in the electrolyte composition.

In one embodiment, the electrolyte composition has a melting point in a range from about 150° C. to about 350° C. In another embodiment, the electrolyte composition has a melting point in a range from about 150° C. to about 325° C. In yet another embodiment, the electrolyte composition has a melting point in a range from about 175° C. to about 300° C.

The electrolyte phase includes a solid sodium halide phase. In one embodiment, the solid sodium halide phase is at least one sodium halide selected from sodium chloride, sodium bromide, sodium iodide, and sodium fluoride, and mixtures thereof. In another embodiment, the solid sodium halide phase includes sodium chloride. In one embodiment, the electrolyte composition can further include one or more alkali metal halides selected from potassium chloride, potassium iodide, potassium bromide, potassium fluoride, lithium iodide, lithium bromide, lithium fluoride, and cesium chloride.

In one embodiment, the electrolyte composition further comprises at least one additive selected from the group consisting of elemental sulfur, metal sulfides, metal iodides, and metal fluorides. In one embodiment, the additive is present in an amount corresponding to from about 1 weight percent to about 10 weight percent based on the total weight of the cathode composition. In another embodiment, the additive is present in an amount corresponding to from about 4 weight percent to about 7 weight percent based on the total weight of the cathode composition. In another embodiment, the energy storage device component includes other additives that may affect performance. Such performance additives can increase ionic conductivity, increase or decrease solubility of the charged cathodic species, improve wetting of the solid electrolyte by the molten electrolyte, and/or prevent ripening of the cathode microdomains, to name several utilities. In one embodiment, the additive may be present in an amount that is less than about 5 mole percent based on the total combined moles of alkali metal halide and aluminum halide present.

In one embodiment, the present invention provides an energy storage device comprising (a) a first compartment comprising an anode; (b) a second compartment comprising a transition metal cathode, a solid sodium halide phase, and an electrolyte phase; and (c) a sodium cation conducting barrier layer disposed between the first compartment and the second compartment. The electrolyte phase includes an electrolyte composition in contact with the transition metal cathode. In one embodiment, the transition metal cathode includes a zero-valent transition metal selected from the group consisting of nickel, iron, cobalt, chromium, manganese, molybdenum, antimony and combinations thereof. The electrolyte composition may be prepared from sodium chloride, lithium chloride and aluminum trichloride. The electrolyte composition comprises the reaction products obtained from an initial mixture of sodium chloride (NaCl), lithium chloride (LiCl) and aluminum trichloride (AlCl₃), the initial mixture being characterized by an initial molar ratio of (NaCl+LiCl):AlCl₃ in a range of from about 0.45:0.55 to about 0.55:0.45 and an initial molar ratio of NaCl:LiCl in a range of from about 0.1:1 to about 4:1.

The first compartment includes an anode. In one embodiment, the anode includes a zero-valent alkali metal. In another embodiment, the anode is zero-valent sodium. In one embodiment, the anode is in a molten state when in use. In another embodiment, the first compartment further includes additives such as for example a metal oxygen scavenger. Suitable metal oxygen scavengers may include but are not limited to manganese, vanadium, zirconium, aluminum, or titanium and the like. In another embodiment, the first compartment further includes additives that can increase wetting of the barrier layer by the molten anode. In one embodiment, the first compartment can receive and store a reservoir of anodic materials. In one embodiment, the first compartment comprises an anode which is a metal shim and which is configured such that sodium metal may be deposited upon it as the energy storage device is being charged. Thus, the energy storage devices provided by the present invention also include the device prior to any first charging step.

The barrier layer (separator) is selective for the transmission of sodium cations between the first compartment and the second compartment. In one embodiment, the barrier layer may comprise an alkali-metal-beta′-alumina, an alkali-metal-beta″-alumina, an alkali-metal-beta′-gallate, an alkali-metal-beta″-gallate, or a combination of two or more of the foregoing. In one embodiment, the barrier layer comprises at least one of a beta-alumina, a beta″-alumina, a gamma alumina, and a micromolecular sieve. Molecular sieves are illustrated by tectosilicates, e.g. a felspar, felspethoid and zeolites. Synthetic zeolites such as ZSM-5 and the like may be employed as the separator in the devices and device components provided by the present invention. In one embodiment, the barrier layer comprises a rare-earth silicophosphate. In another embodiment, the barrier layer comprises a silicon nitride ceramic. In one embodiment, the barrier layer comprises Nasicon (Na₃Zr₂Si₂PO₁₂). In one embodiment, the barrier layer is comprised principally of beta alumina. In one embodiment, the barrier layer comprises alpha alumina and beta alumina. In yet another embodiment, the barrier layer comprises a gamma alumina. In one embodiment, the barrier layer is a micromolecular sieve. In another embodiment, the barrier layer comprised principally of Nasicon. The use of alpha alumina in the barrier layer may be beneficial in certain instances because of its being relatively more amenable to bonding (e.g., compression bonding) than beta alumina, and may help with sealing and/or fabrication of the energy storage device. In various embodiments, the barrier layer comprises on or more stabilizers. Non-limiting examples of stabilizers suitable for use in the barrier layer include Lithia, magnesia, zinc oxide, yttria and similar oxides. These stabilizers may be used alone or in combination with other materials. In one embodiment, the barrier layer comprises beta alumina and is referred to as the beta alumina separator electrolyte (BASE), and can further include one or more dopants.

In one embodiment, the energy storage device provided by the present invention includes a housing having an interior surface defining a volume. In one embodiment, the barrier layer is disposed in the volume. The barrier layer has a first surface that defines at least a portion of a first compartment, and a second surface that defines at least a portion of a second compartment. The first compartment is in ionic communication, with the second compartment through the barrier layer. In various embodiments, the barrier layer is characterized by a cross-sectional profile normal to an axis of the barrier layer. Such a cross-sectional profile normal to an axis of the barrier layer may take a variety of forms, including a circle, a triangle, a square, a cross, a lune, a star, and the like. In an alternate embodiment, the barrier layer is planar. A planar configuration (or with a slight dome) may be useful in a prismatic or button-type battery configuration, where the barrier layer is domed or dimpled. Similarly, the barrier layer can be flat or undulate. In one embodiment, the barrier layer can include a shape which may be flat, undulated, domed, or dimpled. In one embodiment, the barrier layer is tube-like and has cross-sectional profile that may be an ellipsoid, tubular, triangular, cross shaped, star shaped, circular, cloverleaf shaped, rectangular, square, or multi-lobal. The thickness of the barrier layer may vary depending on design parameters. In one embodiment, the barrier layer has an average thickness of less than 2 millimeters.

In one embodiment, the energy storage device can have a plurality of current collectors for example an anode current collector and a cathode current collector. The anode current collector is in electrical communication with the first compartment and the cathode current collector is in electrical communication with the second compartment. Suitable materials for the anode current collector include W, Ti, Ni, Cu, Mo, carbon or combinations thereof. The cathode current collector may vary in shape. Suitable shapes include a rod, a wire, a paddle, a mesh, and combinations thereof. The cathode current collector may comprise a variety of different conductive metals including Pt, Pd, Mo, W, Au, Ni, Cu, C, or Ti. In one embodiment, the current collector is plated. In an alternate embodiment, the current collector is clad. Typically, the current collector will have a thickness of greater than about 1 millimeter (mm).

In another embodiment, the energy storage device further includes a second energy storage device that differs from the energy storage device to provide an energy management system. This duel energy storage device system can address the ratio of power to energy in that a first energy storage device can be optimized for efficient energy storage, and a second energy storage device can be optimized for power delivery. The control system can draw from either energy storage device as needed, and charge back either energy storage device that needs such a charge. Suitable second energy storage devices are exemplified by a primary battery, a secondary battery, a fuel cell, and an ultracapacitor. A suitable secondary battery may be a lithium battery, lithium ion battery, lithium polymer battery, or a nickel metal hydride battery.

In one embodiment, a system that includes the energy storage device is provided for example an electrical system aboard a space vehicle. In another, embodiment, the system is an electric locomotive, tug boat, mine vehicle, heavy duty truck, car, uninterrupted power supply unit, telecommunication unit, intermittent solar energy production unit, intermittent wind energy production unit.

In various embodiments, the energy storage devices provided by the present invention are rechargeable over a plurality of charging and discharging cycles. In one embodiment, a method of operating an energy storage device is provided. The method includes the steps of (a) applying a effective voltage differential to the cathode and anode of an energy storage device to provide a energy storage device comprising stored energy; and (b) discharging the stored energy through a “resistive load” (at times herein also referred to as a useful load), wherein the energy storage device is operated at a temperature in a range between 250° C. and about 350° C. during the discharging. The energy storage device includes a first compartment that includes an anode: a second compartment comprising a transition metal cathode comprising a transition metal selected from the group consisting of nickel, iron, cobalt, chromium, manganese, molybdenum, antimony and combinations thereof, a solid sodium halide phase, and a molten electrolyte phase. The molten electrolyte phase includes an electrolyte composition prepared from sodium chloride, lithium chloride and aluminum trichloride. The electrolyte composition includes the reaction products obtained from an initial mixture of sodium chloride (NaCl), lithium chloride (LiCl) and aluminum trichloride (AlCl₃), the initial mixture being characterized by an initial molar ratio of (NaCl+LiCl):AlCl₃ in a range of from about 0.45:1 to about 0.55:1 and an initial molar ratio of NaCl:LiCl in a range of from about 0.1:1 to about 4:1. The energy storage device includes a sodium cation conducting barrier layer disposed between the first compartment and the second compartment.

The energy storage device comprising stored energy is discharged through a useful load. Suitable examples of useful loads include but are not limited to electric motors and light sources. In one embodiment, the energy storage device is operated at a temperature in a range between 250° C. and about 350° C. during the discharging step. In another embodiment, the energy storage device is operated at a temperature in a range between 280° C. and 330° C. during the discharging step.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

### EXAMPLES

The following examples illustrate methods and embodiments in accordance with the invention.

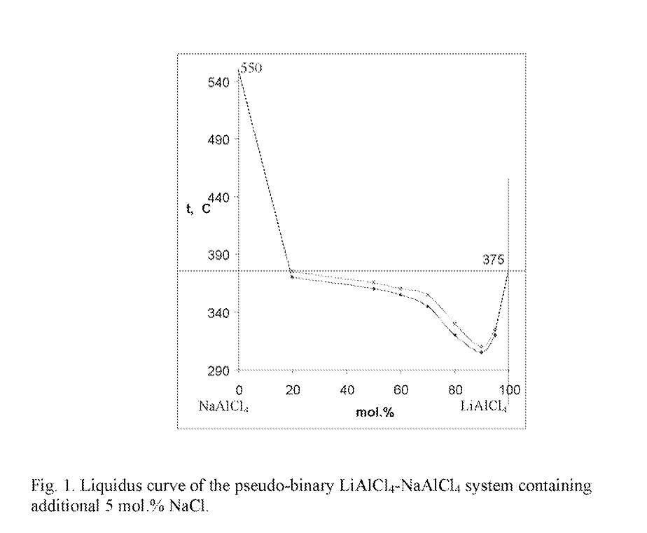

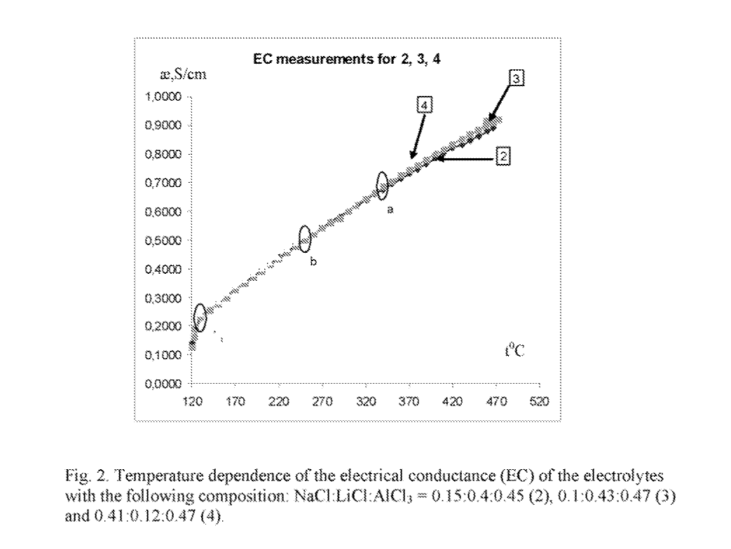

The following chemicals were used as received: aluminum chloride (anhydrous, ≧98%) and lithium chloride (>99%). Sodium chloride (99.99%) was fused at 830-850° C. in a quartz tube before use. The samples of the salts before fusion were ground together to fine powder state in an agate mortar in an argon-filled glove box and placed in Pyrex tubes. A Pyrex tube containing the sample (2-3 g) was quickly heated to 400° C. under constant stirring to obtain a homogeneous, transparent melt. The average loss of the sample mass was 0.5-1.5% by weight of the mass of the sample initially placed in the Pyrex tube. This mass loss was attributed to loss of the relatively volatile aluminum trichloride. Each composition given for each of Examples 1-7 has been corrected for this weight loss attributed to AlCl₃ loss. The initial crystallization temperature of molten electrolytes was determined by visual observation and confirmed by differential thermal analysis (DTA). Results for electrolytes representing a pseudo binary NaAlCl₄:LiAlCl₄ system containing an additional 5 mol. % NaCl with the composition also expressed in the NaCl:LiClAlCl₃ ratios are presented in Table and FIG. 1. As can be seen, addition of LiCl to the NaClAlCl₃ system substantially and usefully decreases the melting point of ternary mixtures. The NaAlCl₄:LiAlCl₄ system containing 90 mol % LiAlCl₄ is capable of dissolving nearly 5 mol % NaCl at the battery working temperature. This stands in sharp contrast to a solubility of NaCl of less that 1 mol % in pure NaAlCl₄ under similar conditions. Thus, the electrolyte compositions provided by the present invention exhibit a significantly enhanced capacity to dissolve and therefore transport NaCl within the energy storage device. Conductivity measurements of molten electrolytes containing LiCl showed that the conductance is only slightly less than the conductance of pure NaAlCl₄ (0.55-0.57 S/cm vs. 0.68 S/cm) (FIG. 2).

TABLE
Temperature of initial crystallization of electrolytes representing
pseudo binary NaAlCl₄:LiAlCl₄ system with additional 5 mol. % NaCl.

| | Ratio NaCl:LiCl:AlCl₃ | Ratio NaAlCl₄:LiAlCl₄ | |
|---|---|---|---|
| Example | (mol %) | (mol %) | T_{init. cr.}° C. |
| 1 | 41.4:9.8:48.8 | 80:20 | 370-375 |
| 2 | 26.8:24.4:48.8 | 50:50 | 360-365 |
| 3 | 21.9:29.3:48.8 | 40:60 | 355-360 |
| 4 | 17.134.1:48.8 | 30:70 | 345-355 |
| 5 | 12.2:39.0:48.8 | 20:80 | 320-330 |
| 6 | 7.3:43.9:48.8 | 10:90 | 305-310 |
| 7 | 4.9:46.3:48.8 | 5:95 | 320-325 |

The foregoing examples are merely illustrative, serving to exemplify only some of the features of the invention. The appended claims are intended to claim the invention as broadly as it has been conceived and the examples herein presented are illustrative of selected embodiments from a manifold of all possible embodiments. Accordingly, it is the Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied; those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

What is claimed is:

1. An energy storage device component comprising:
a transition metal cathode comprising a transition metal selected from the group consisting of nickel, iron, cobalt, chromium, manganese, molybdenum, antimony and combinations thereof;
a solid sodium halide phase; and
an electrolyte phase comprising an electrolyte composition prepared from sodium chloride, lithium chloride and aluminum trichloride, the electrolyte composition being in contact with the cathode, the electrolyte composition comprising the reaction products obtained from an initial mixture of sodium chloride (NaCl), lithium chloride (LiCl) and aluminum trichloride (AlCl₃), the initial mixture being characterized by an initial molar ratio of (NaCl+LiCl):AlCl₃ in a range of from about 0.45:0.55 to about 0.55:0.45 and an initial molar ratio of NaCl:LiCl in a range of from about 0.1:1 to about 4:1.

2. The energy storage device component according to claim 1, wherein the electrolyte phase is in a molten state.

3. The energy storage device component according to claim 1, wherein the electrolyte phase is in a solid state.

4. The energy storage device component according to claim 1, wherein the transition metal is nickel.

5. The energy storage device component according to claim 1, wherein the cathode further comprises a transition metal chloride.

6. The energy storage device component according to claim 1, wherein the initial molar ratio of NaCl:LiCl is in a range of from about 0.1:1 to about 0.65:1.

7. The energy storage device component according to claim 1, wherein the initial molar ratio of (NaCl+LiCl):AlCl₃ is in a range of from about 0.47:0.53 to about 0.55:0.45 and the initial molar ratio of NaCl:LiCl is in a range of from about from 0.1:1 to about 0.25:1.

8. The energy storage device component according to claim 1, wherein the electrolyte composition has a melting point in a range from about 150° C. to about 350° C.

9. The energy storage device component according to claim 1, wherein the electrolyte composition has a melting point in a range from about 150° C. to about 325° C.

10. The energy storage device component according to claim 1, wherein the electrolyte composition has a melting point in a range from about 175° C. to about 300° C.

11. The energy storage device component according to claim 1, wherein the transition metal cathode further comprises aluminum.

12. The energy storage device component according to claim 1, wherein the electrolyte composition further comprises at least one additive selected from the group consisting of sulfur, metal sulfides, metal iodides, and metal fluorides.

13. A battery comprising the energy storage device component defined by claim 1.

14. An energy storage device comprising:
a first compartment comprising an anode;
a second compartment comprising a transition metal cathode comprising a transition metal selected from the group consisting of nickel, iron, cobalt, chromium, manganese, molybdenum, antimony and combinations thereof;
a solid sodium halide phase;
an electrolyte phase comprising an electrolyte composition prepared from sodium chloride, lithium chloride and aluminum trichloride, the electrolyte composition being in contact with the cathode, the electrolyte composition comprising the reaction products obtained from an initial mixture of sodium chloride (NaCl), lithium chloride (LiCl) and aluminum trichloride (AlCl₃), the initial mixture being characterized by an initial molar ratio of (NaCl+LiCl):AlCl₃ in a range of from about 0.45:0.55 to about 0.55:0.45 and an initial molar ratio of NaCl:LiCl in a range of from about 0.1:1 to about 4:1; and
a sodium cation conducting barrier layer disposed between the first compartment and the second compartment.

15. The energy storage device according to claim 14, wherein the cathode further comprises a transition metal chloride.

16. The energy storage device according to claim 14, wherein the anode comprises an alkali metal.

17. The energy storage device according to claim 14, wherein the anode comprises sodium metal.

18. The energy storage device according to claim 14, wherein the barrier layer comprises a beta-alumina, a beta″-alumina, a gamma alumina, a micromolecular sieve, or nasicon.

19. A method of operating an energy storage device comprising the steps of:
(a) applying an effective voltage differential to the cathode and anode of an energy storage device, the device comprising;
a first compartment comprising an anode;
a second compartment comprising a transition metal cathode comprising a transition metal selected from the group consisting of nickel, iron, cobalt, chromium, manganese, molybdenum, antimony and combinations thereof;
a solid sodium halide phase;
a molten electrolyte phase comprising an electrolyte composition prepared from sodium chloride, lithium chloride and aluminum trichloride, the electrolyte composition being in contact with the cathode, the electrolyte composition comprising the reaction products obtained from an initial mixture of sodium chloride (NaCl), lithium chloride (LiCl) and aluminum trichloride (AlCl₃), the initial mixture being characterized by an initial molar ratio of (NaCl+LiCl):AlCl₃ in a range of from about 0.45:1 to about 0.55:1 and an initial molar ratio of NaCl:LiCl in a range of from about 0.1:1 to about 4:1; and
a sodium cation conducting barrier layer disposed between the first compartment and the second compartment; and
(b) discharging the stored energy through a resistive load,
wherein the energy storage device is operated at a temperature in a range from about 250° C. and about 350° C. during the discharging.

20. An energy storage device comprising:
a first compartment comprising a sodium anode;
a second compartment comprising a transition metal cathode comprising nickel;
a solid sodium halide phase;
an electrolyte phase comprising an electrolyte composition prepared from sodium chloride, lithium chloride and aluminum trichloride, the electrolyte composition being in contact with the cathode, the electrolyte composition comprising the reaction products obtained from an initial mixture of sodium chloride (NaCl), lithium chloride (LiCl) and aluminum trichloride (AlCl₃), the initial mixture being characterized by an initial molar ratio of (NaCl+LiCl):AlCl₃ in a range of from about 0.45:1 to about 0.55:1 and an initial molar ratio of NaCl:LiCl in a range of from about 0.1:1 to about 4:1; and
a sodium cation conducting barrier layer comprising beta alumina disposed between the first compartment and the second compartment.

21. A system comprising an energy storage device according to claim 20.

22. A system according to claim 20, which is an electric locomotive, tug boat, mine vehicle, heavy duty truck, car, uninterrupted power supply unit, telecommunication unit, intermittent solar energy production unit, intermittent wind energy production unit.
